(19) United States
(12) Patent Application Publication
(10) Pub. No.: US 2006/0203163 A1
(43) Pub. Date: Sep. 14, 2006

(54) Optical compensation film, elliptical polarizing plate, and liquid crystal device

(75) Inventor: Tomoki Tasaka, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/373,300

(22) Filed: Mar. 13, 2006

(30) Foreign Application Priority Data
Mar. 11, 2005 (JP) P. 2005-069306

(51) Int. Cl. G02F 1/1335

(52) U.S. Cl. 349/117

(57) ABSTRACT

An optical compensation film comprising a liquid crystal layer containing a liquid crystal having a dispersion of alignment of 0.3° or smaller.

### FIELD OF THE INVENTION

This invention relates to an optical compensation film, an elliptical polarizing plate, and a liquid crystal display (hereinafter, “LCD”).

### BACKGROUND OF THE INVENTION

An optical compensation film is used in LCDs for the purpose of widening the viewing angle or eliminating image discoloration. An optical compensation film is usually used as united with a polarizing plate to make an elliptical polarizing plate.

An optical compensation film having a liquid crystal compound applied to a transparent substrate is known (see, e.g., Japanese Patent 2587398). Use of liquid crystal compounds, which take on various alignments, makes it feasible to draw optical properties that are not attainable with conventional stretched birefringent polymer films. With the recent breakthroughs in display quality of LCDs, the demand for optical compensation films with higher quality has been increasing.

### SUMMARY OF THE INVENTION

In fabricating an LCD using an optical compensation film, the front retardation of the optical compensation film and that of a liquid crystal cell are adjusted to be in agreement with each other so as not to cause light leakage theoretically. In fact, nevertheless, where an optical compensation film is inserted, although the viewing angle is widened, light leakage occurs in a black display state, causing reduction in front contrast.

The present invention has been completed in the light of the above problem. An object of the invention is to provide an optical compensation film that improves viewing angle dependence of an LCD and provides a high front contrast.

The present inventors have investigated into a cause of reduction of front contrast that occurs where an optical compensation film having a liquid crystal compound is inserted. It has been found as a result that thermal fluctuation of molecular alignment of the liquid crystal compound is fixed as such when the liquid crystal compound is cured in fabricating an optical compensation film so that fluctuation of refractive index remains in the cured film and causes light scattering. Hence, the inventors define dispersion or distribution of alignment of liquid crystal molecules as hereinafter described as a measure reflecting residual thermal fluctuation of a liquid crystal compound. They have ascertained that use of an optical compensation film with a reduced dispersion of alignment achieves improvement on both viewing angle and front contrast of an LCD and thus reached the present invention.

The above object of the invention is accomplished by: 1. An optical compensation film having a liquid crystal layer containing a liquid crystal having a dispersion of alignment of 0.3° or smaller. 2. The optical compensation film in which the liquid crystal compound contains an optically negative uniaxial liquid crystal compound. 3. An elliptical polarizing plate having the optical compensation film of the invention. 4. An LCD having the optical compensation film of the invention or the elliptical polarizing plate of the invention.

The present invention provides an optical compensation film and an elliptic polarizing plate which use a liquid crystal compound having a small dispersion of alignment and thereby reduce viewing angle dependence and improve front contrast of an LCD. The present invention also provides an LCD that uses the optical compensation film of the invention and therefore has reduced viewing angle dependence while securing high front contrast.

### BRIEF DESCRIPTION OF THE DRAWINGS

FIG. 1 is a schematic exploded view of an embodiment of the LCD of the invention.

FIG. 2 schematically illustrates an example of a pixel size area of the LCD of the invention.

### DETAILED DESCRIPTION OF THE INVENTION

The optical compensation sheet of the invention has a liquid crystal layer containing a liquid crystal compound having a dispersion of alignment of 0.3° or smaller. The term “dispersion of alignment” as used herein is a measure obtained as follows. Method of measuring dispersion of alignment of liquid crystal:

An optical compensation film having a liquid crystal layer is set on a polarizing microscope between two polarizers arranged in a crossed Nicols state. The image is photographed at 100 magnifications with a digital camera attached to the microscope while rotating the stage by 0.02 degrees within a range of ±5 degrees from the angle at which the image is darkest. The digital micrographs are accurately registered pixel-by-pixel with each other by rotation and parallel translation. The angle at which each pixel is darkest is recorded. The number of pixels that become darkest is plotted as ordinate against angle as abscissa to prepare a histogram. The difference between the most plus angle and the most minus angle of the angles showing half the maximum height of the histogram (i.e., a half value width) is taken as a dispersion of alignment of a liquid crystal compound.

Any known polarizing microscope can be used for the measurement. Eclipse E600POL from Nicon is an example. The image processing by rotation and parallel translation can be done with a commercially available program.

The dispersion of alignment of liquid crystal molecules is preferably as small as possible and ideally zero degree. A practically preferred range of the dispersion of alignment is 0.0° to 0.3°, still preferably 0.0° to 0.1°.

There are various means available to form a liquid crystal layer with a small dispersion of alignment. One of them is to use a liquid crystal compound having a large Frank elasticity constant to make the liquid crystal layer. A liquid crystal compound having a Frank elasticity constant of 10 pN or greater, still preferably 20 pN or greater, is preferably used. Such a liquid crystal compound includes a 4,4′-di(hexaalkoxy) azoxybenzene.

Another means is to use an alignment film having strong alignment control force. Such an alignment film includes an Sio vacuum deposition film and alignment films RN1119 and SE150 available from Nissan Chemical Industries, Ltd.

It is an effective means to increase the contact area between the liquid crystal compound and an alignment film. For this purpose, a liquid crystal layer may be fixed with an alignment film additionally provided in contact with the air interface side of the liquid crystal layer.

In order to narrow the dispersion of alignment of a liquid crystal layer, it is also effective to fix a liquid crystal layer in low temperature to reduce thermal fluctuation of the liquid crystal in the step of forming the liquid crystal layer. The fixation temperature is preferably lower than 400 K, still preferably lower than 300 K.

An electric field or a magnetic field may be applied to the liquid crystal layer while being fixed. Electric field application is achieved by applying voltage to the optical compensation film sandwiched between electrodes. The electric field intensity to be applied is preferably 1 kV/cm or higher, still preferably 3 kV/cm or higher. Magnetic field application is carried out by sandwiching the optical compensation film between electromagnets. The magnetic field intensity to be applied is preferably 1 T or higher, still preferably 3 T or higher.

The optical compensation film of the invention preferably has a front retardation (Re) of 10 to 600 nm, still preferably 50 to 500 nm. The thickness direction retardation (Rth) of the optical compensation film is not particularly limited but, in general, preferably in a range of from 10 to 600 nm, still preferably 50 to 500 nm. In the present invention, the front retardation Re and the thickness direction retardation Rth are defined by formulae (1) and (2) shown below, respectively.
Re=(nx−ny)×d (1)
Rth={(nx+ny)/2 -nz}×d (2)
wherein nx and ny are in-plane refractive indices (nx≧ny); nz is a refractive index along the thickness direction; and d is a film thickness.

The liquid crystal layer of the optical compensation film can be formed on an alignment film, The alignment film may be formed on a transparent substrate, etc. Each of elements constituting the optical compensation film of the invention will hereinafter be described.

The liquid crystal layer contains a liquid crystal compound fixed in an aligned state. The liquid crystal compound in the liquid crystal layer is preferably an optically negative uniaxial liquid crystal compound, which is preferably a discotic liquid crystal compound having a disc-shaped molecular structure. It is preferred that the discotic liquid crystal compound molecules be fixed in an aligned state in the liquid crystal layer with their optical axis parallel with the substrate. More specifically, it is preferred that the discotic liquid crystal molecules be aligned with their optical axes tilted at an average tilt angle of 0° to 20° with respect to the substrate plane. Where the average tilt angle is smaller than that range, the light leakage distribution can sometimes be asymmetrical. When the optical compensation film of the invention is applied to an IPS (in-plane switching) mode LCD, it is preferred that the slow axis direction of the liquid crystal layer be parallel with the transmission axis of the polarizing film nearer to the optical compensation film and the slow axis of the liquid crystal molecules in the liquid crystal cell in a black display state.

The front retardation Re of the liquid crystal layer preferably ranges from 10 to 600 nm, still preferably 50 to 500 nm. The front retardation Re of the liquid crystal layer can be adjusted within a desired range by controlling the thickness of the liquid crystal layer, for example, the amount of a liquid crystal-containing coating composition applied to form the liquid crystal layer.

Discotic liquid crystal compounds that can be used in the present invention are described in various references including C. Destrade et al., Mo2. Liq. Cryst., vol. 71, p. 111 (1981), The Chemical Society of Japan (ed.), Kikan Kagaku Sosetsu, No. 11, Ekisyo no Kagaku, Ch. 5, Ch. 10, Sec. 2 (1994), B. Kohne et al., Angew. Chem. Soc. Chem. Comm., p. 1794 (1985), and J. Zhang et al., J. Am. Chem. Soc., vol. 116, p.2655 (1994). JP-A-8-27284 teaches polymerization of discotic liquid crystal compounds.

The discotic liquid crystal compound preferably has a polymerizable group so as to be fixed by polymerization. The discotic liquid crystal compound may have a structure with a polymerizable group bonded to the discotic core thereof. However, molecules with a polymerizable group directly bonded to the discotic core have difficulty in maintaining their aligned state while being polymerized. It is hence preferred for the compound to have a polymerizable group bonded to the discotic core via a linking group. That is, the discotic liquid crystal compound having a polymerizable group is preferably a compound represented by formula;
D (-L-P)n
wherein D is a discotic core; L is a divalent linking group; P is a polymerizable group; and n is an integer of 4 to 12. Preferred examples of the discotic core (D), the divalent linking group (L), and the polymerizable group (P) are given in JP-A-2001-4837 with designations (D1) to (D15), (L1) to (L25), and (P1) to (P18), respectively. The teachings described in the publication are preferably applied to the present invention.

In forming the liquid crystal layer from the discotic liquid crystal compound, it is preferred that the molecules be aligned with their optical axis parallel with the substrate plane as stated above. To assure such a molecular alignment, the average angle (average tilt angle) of the disc plane with respect to the substrate plane is preferably in a range of from 70° to 90°. The liquid crystal compound molecules may be aligned obliquely or aligned such that the tilt angle varies along the thickness direction, i.e., hybrid-aligned. Either way, the average tilt angle is desirably from 70° to 90°, more desirably from 75° to 90°, and even more desirably from 80° to 90°.

The liquid crystal layer is preferably formed by coating an alignment film on a substrate with a coating composition containing the above-described liquid crystal compound, preferably the discotic liquid crystal compound, an optional polymerization initiator, an optional additive for alignment on an air interface, and any other optional additives.

An organic solvent is preferably used to prepare the coating composition. Examples of suitable solvents include amides (e.g., N,N-dimethylformamide), sulfoxides (e.g., dimethyl sulfoxide), heterocyclic compounds (e.g., pyridine), hydrocarbons (e.g., benzene and hexane), alkyl halides (e.g., chloroform and dichloromethane), esters (e.g., methyl acetate and butyl acetate), ketones (e.g., acetone and methyl ethyl ketone), and ethers (e.g., tetrahydrofuran and 1,2-dimethoxyethane). Preferred of them are alkyl halides and ketones. Two or more organic solvents may be used in combination. The coating composition can be applied by known coating methods, such as extrusion coating, direct gravure coating, reverse gravure coating, and die coating.

The aligned liquid crystal compound is preferably fixed while maintaining the aligned state. Fixation is preferably effected by polymerization reaction of the polymerizable group (P) introduced into the liquid crystal compound. The polymerization reaction includes thermal polymerization reaction using a thermal polymerization initiator and photopolymerization reaction using a photopolymerization initiator. The latter polymerization is preferred. Examples of useful photopolymerization initiators are α-carbonyl compounds (described in U.S. Pat. Nos. 2,367,661 and 2,367,670), acyloin ethers (described in U.S. Pat. No. 2,448,828), α-hydrocarbon-substituted aromatic acyloin compounds (described in U.S. Pat. No. 2,722,512), polynuclear quinone compounds (described in U.S. Pat. Nos. 3,046,127 and 2,951,758), combinations of a triarylimidazole dimer and a p-aminophenyl ketone (described in U.S. Pat. No.3,549,367), acridine and phenazine compounds (described in JP-A-60-105667 and U.S. Pat. No. 4,239,850), and oxadiazole compounds (described in U.S. Pat. No. 4,212,970).

The amount of the photopolymerization initiator to be used is preferably from 0.01% to 20% by weight, still preferably 0.5% to 5% by weight, based on the solids content of the coating composition. Photopolymerization of discotic liquid crystal molecules is preferably induced by irradiation with ultraviolet light. The irradiation energy is preferably 20 to 50 J/cm², still preferably 100 to 800 mJ/cm^{2.} As stated previously, it is effective for the reduction of dispersion of alignment to conduct polymerization in a relatively low temperature or to apply an electric field or a magnetic field to the reaction system during polymerization.

The thickness of the liquid crystal layer is preferably 0.1 to 10 μm, still preferably 0.5 to 5 μm, even still preferably 1 to 5 μm.

To align discotic liquid crystal molecules with their optical axes parallel with a substrate plane on the side of an alignment film, it is recommended to form the liquid crystal layer on the alignment film. It is especially effective to use an alignment film having a low surface energy. Specifically, a polymer having a prescribed functional group provides an alignment film with a surface energy reduced by the functional group. Such an alignment film is capable of aligning liquid crystal molecules applied thereon vertically.

Functional groups effective in reducing the surface energy of an alignment film include a fluorine atom and a hydrocarbon group having 10 or more carbon atoms. A fluorine atom or the hydrocarbon group is preferably introduced into a side chain rather than the main chain of a polymer so that the fluorine atom or the hydrocarbon group may be exposed on the surface of the alignment film. A fluorine-containing polymer preferably has a fluorine content of 0.05% to 80% by weight, still preferably 0.1% to 70% by weight, even still preferably 0.5% to 65% by weight, yet preferably 1% to 60% by weight. The hydrocarbon group is an aliphatic group, an aromatic group or a combination thereof. The aliphatic group may be cyclic, branched or linear. The aliphatic group is preferably an alkyl group (including a cycloalkyl group) or an alkenyl group (including a cycloalkenyl group). The hydrocarbon group may have a low-hydrophilic substituent such as a halogen atom. The carbon atom number of the hydrocarbon group is preferably 10 to 100, still preferably 10 to 60, and even still preferably 10 to 40. The main chain of the polymer preferably has a polyimide or polyvinyl alcohol structure.

Polyimides are generally synthesized by condensation reaction of a tetracarboxylicacidandadiamine. Co-polyimides produced by condensation using two or more tetracarboxylic acid components and/or two or more diamine components are useful as well. A fluorine atom or a hydrocarbon group as a functional group may have its origin in a tetracarboxylic acid and/or a diamine. When a hydrocarbon group is introduced into polyimide, it is preferred that a steroid structure be formed in the main chain or the side chain of the polyimide. The steroid structure in the side chain corresponds to a hydrocarbon group having 10 or more carbon atoms and contributes to aligning liquid crystal molecules with their optical axes parallel with the substrate. In the present invention, the term “steroid structure” is used to mean a cyclopentanohydrophenanthrene ring structure or a ring structure derived therefrom by replacing part of the single bonds thereof with a double bond provided that the replacement does not result in an aromatic ring.

The alignment film for aligning the liquid crystal molecules with their optical axis parallel with the substrate plane additionally includes one formed of a composition obtained by mixing an organic acid into a polymer, such as polyvinyl alcohol, modified polyvinyl alcohol or polyimide. Examples of the organic acid to be mixed include carboxylic acids, sulfonic acids, and amino acids. The amount of the organic acid to be mixed is preferably 0.1% to 20% by weight, still preferably 0.5% to 10% by weight, based on the polymer.

The saponification degree of the polyvinyl alcohol is preferably 70% to 100%, still preferably 80% to 100%. The polymerization degree of the polyvinyl alcohol is preferably 100 to 5000.

To align discotic liquid crystal molecules, it is preferred to use a polymer having a hydrophobic group on its side chain as a functional group to form the alignment film. The kind of the functional group is decided depending on the kid of the liquid crystal compound and a desired alignment state. For example, modified polyvinyl alcohol is prepared by introducing a modifying group into polyvinyl alcohol through copolymerization, chain transfer or block polymerization. Examples of the modifying group include hydrophilic groups, such as a carboxyl group, a sulfonic acid group, a phosphonic acid group, an amino group, an ammonium group, an amide group, and a thiol group; hydrocarbon groups having 10 to 100 carbon atoms; fluorine-substituted hydrocarbon groups; thioether groups; polymerizable groups, such as an unsaturated polymerizable group, an epoxy group, and an aziridinyl group; and alkoxysilyl groups, such as tri-, di- or mono-alkoxysilyl groups. Specific examples of the modified polyvinyl alcohols are given in paras. [0022] to [0145] in JP-A-2000-155216 and those described in paras. [0018] to [0022] in JP-A-2002-62426.

When the alignment film is made of a polymer having a side chain and a crosslinkable functional group bonded to the main chain thereof or a polymer having a aide chain functioning to align liquid crystal molecules and a crosslinkable functional group bonded to the side chain thereof, and a liquid crystal layer is formed thereon using a composition containing a polyfunctional monomer, it is possible to cause the polymer in the alignment film and the polyfunctional monomer in the liquid crystal layer to copolymerize with each other. As a result, a covalent bond is formed not only between the polyfunctional monomer molecules but between the polymer molecules of the alignment film and between the polyfunctional monomer and the polymer of the alignment film. The alignment film and the liquid crystal film are thus bonded to each other firmly. That is, the strength of the optical compensation film can markedly be improved by forming the alignment film using a polymer having a crosslinkable functional group. The crosslinkable functional group possessed by the polymer of the alignment film preferably contains a polymerizable group similarly to the polyfunctional monomer. Specific examples of the crosslinkable functional group include those described in paras. [0080] to [0100] in JP-A-2000-155216.

The polymer of the alignment film may also be crosslinked by the aid of a crosslinking agent. Useful crosslinking agents include aldehydes, N-methylol compounds, dioxane derivatives, compounds capable of acting as a crosslinking agent when their carboxyl group is activated, active vinyl compounds, active halogen compounds, isoxazoles, and dialdehyde starches. Two or more crosslinking agents may be used in combination. Specific examples of the crosslinkable agents include the compounds described in paras. [0023] to [0024] of JP-A-2002-62426. Aldehydes having high reaction activity, particularly glutaraldehyde is preferred.

The amount of the crosslinking agent is preferably 0.1% to 20% by weight, still preferably 0.5% to 15% by weight, based on the polymer. The residual amount of the unreacted crosslinking agent in the alignment film is desirably not greater than 1.0% by weight, still preferably not greater than 0.5% by weight. With the residual crosslinking agent content so controlled, the alignment film has sufficient durability without suffering from reticulation even when it is used in an LCD for a long time or left to stand in high temperature and humidity for a long time.

The alignment film is prepared basically by applying a coating composition containing the above polymer and, if necessary, the crosslinking agent, to a transparent substrate, heat drying (crosslinking), and performing a rubbing treatment. The crosslinking reaction may be carried out at any stage after applying the coating composition Where a water-soluble polymer such as polyvinyl alcohol is used to make an alignment film, the coating composition is desirably prepared using a mixed solvent of an organic solvent having a defoaming function, such as methanol, and water. The weight ratio of water to methanol is preferably 0/100to 99/1, still preferably 0/100to 91/9. Using such a mixed solvent prevents foaming and significantly reduces defects of the alignment film and eventually reduces defects of the surface of a retardation film.

The coating composition for alignment film is preferably applied by spin coating, dip coating, curtain coating, extrusion coating, rod coating or roll coating. Rod coating is especially preferred. The coating composition is preferably applied to a dry thickness of 0.1 to 10 μm. Heat drying is usually at 20° to 110° C. To secure sufficient crosslinking, heat drying is preferably effected at 60° to 100° C., still preferably 80° to 100° C. The drying time is usually from 1 minute to 36 hours, preferably 1 minute to 30 minutes. The pH of the coating composition is preferably adjusted as appropriate to the crosslinking agent used. In using glutaraldehyde as a crosslinking agent, a preferred pH is 4.5 to 5.5, still preferably 5.

The rubbing treatment is usually carried out in a way widely adopted for liquid crystal alignment in LCD fabrication. Specifically, alignment will be achieved by rubbing the surface of the alignment film with paper, gauze, felt, rubber, cotton, rayon, nylon, polyester fiber or the like in a given direction. Other alignment control means, such as light and vapor deposition, may be used. As long as liquid crystal molecules are aligned in the way desired, the means for alignment control is not limited. Usually, the alignment control treatment is carried out by rubbing the alignment film several times with a cloth having fibers uniform in length and thickness implanted uniformly.

The optical compensation film of the invention may be formed on a substrate. The substrate is preferably transparent and, in particular, preferably has a light transmission of at least 80%. The substrate preferably has a small wavelength dispersion and, in particular, preferably has an Re400 to Re700 ratio of less than 1.2. It is preferred for the substrate to have small optical anisotropy, particularly to have a front retardation (Re) of 20 nm or smaller, still preferably 10 nm or smaller.

The substrate is preferably formed of a polymer film. Examples of polymer materials for the substrate include cellulose esters, polycarbonates, polysulfones, polyether sulfones, polyacrylates, and polymethacrylates. Among them, cellulose esters are preferred, acetyl celluloses are more preferred, and triacetyl cellulose is the most preferred. The thickness of the substrate is desirably from 20 to 500 μm, and more desirably from 50 to 200 μm. To improve adhesion between the substrate and a layer formed thereon (for example, an alignment film or a liquid crystal layer), the transparent substrate may be subjected to surface treatment, such as corona discharge treatment, glow discharge treatment, UV treatment or flame treatment. An adhesive layer (an undercoating layer) may be provided on the substrate.

The optical compensation film of the present invention is preferably laminated with a polarizing film to make an elliptical polarizing plate for use in LCDs. A polarizing film is usually supplied as sandwiched in between a pair of protective films. The substrate of the optical compensation film of the invention serves as one of the protective films, which will make contribution to thickness reduction of LCDs. The polarizing film and the protective film for the polarizing film will then be described.

Polarizing films include an iodine polarizer, a dichroic polarizer using a dichroic dye, and a polyene polarizer. The iodine polarizer and the dichroic polarizer are generally prepared using polyvinyl alcohol film. The transmission axis of the polarizing film corresponds to a direction perpendicular to the stretch direction of the film. Where a discotic liquid crystal compound is used to form the liquid crystal layer, the polarizing film is disposed so that its transmission axis may be substantially parallel with the disc plane of the discotic liquid crystal compound molecules on the alignment film side. In using a rod-like liquid crystal compound, the polarizing film is disposed with its transmission axis substantially parallel with the length direction (slow axis) of the rod-like liquid crystal compound. The polarizing film is usually bonded to the substrate side of the optical compensation film of the invention but may be bonded to the liquid crystal layer side of the optical compensation film if desired.

The opposite side of the polarizing film to the optical compensation film is preferably protected with a transparent protective film. The protective film preferably has no absorption in the visible light region, an optical transmission of 80% or higher, and a small retardation by birefringence. More specifically, it is preferred for the protective film to have a front retardation Re of 20 nm or less, still preferably 10 nm or less, even still preferably 5 nm or less, and a thickness direction retardation Rth of 20 nm or less, still preferably 10 nm or less, even still preferably 5 nm or less. While any film having such properties can be advantageously employed, a cellulose acetate film or a norbornene type film is preferred in consideration of durability of the polarizing film. For reducing Rth of a cellulose acetate film, it is effective to incorporate a liquid crystal compound into the film.

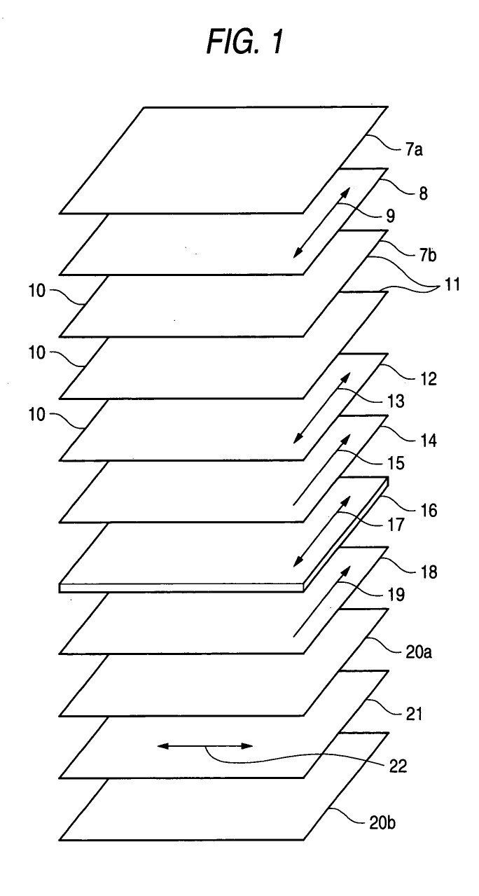

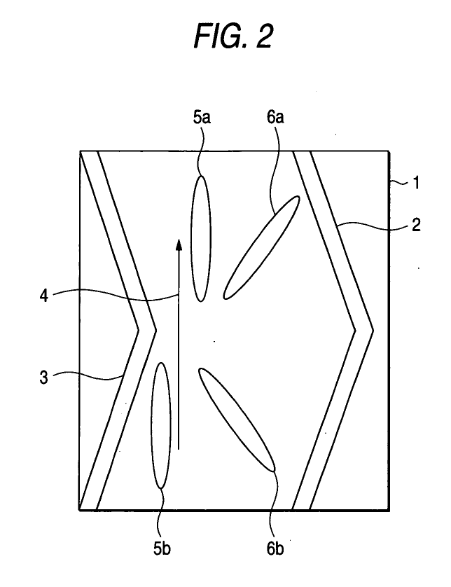

An embodiment of the LCD of the present invention will be illustrated in detail with reference to the accompanying drawings, in which FIG. 1 is a schematic exploded view of an embodiment of the LCD of the invention, and FIG. 2 schematically illustrates an example of a pixel size area of the LCD of the invention.

The LCD shown in FIG. 1 has a first polarizing film 8, an optical compensation film 10, a first substrate 14, a liquid crystal cell 16, a second substrate 18, and a second polarizing film 21. The first polarizing film 8 and the second polarizing film 21 are each sandwiched between the respective protective films 7a, 7b and 20a, 20b. The optical compensation film 10 is composed of the protective film 7b in contact with the first polarizing film 8, an alignment film 11, and a liquid crystal layer 12.

The liquid crystal cell 16 is held between the first substrate 14 and the second substrate 18. The product (Δn-d) of a thickness d (μm) of the liquid crystal cell times a refractive index anisotropy Δn is optimally within a range of from 0.2 to 0.4 μm in an IPS cell having no twisted structure in a transmission mode. Within that range, the luminance is high in a white display state and low in a black display state to give high brightness and high contrast. On the surface of each of the substrates 14 and 18 in contact with the liquid crystal cell 16, an alignment film (not shown) is provided to align the liquid crystal molecules substantially parallel to the substrate surface. The alignment films have been rubbed in the respective rubbing directions 15 and 19 to control the alignment direction of the liquid crystal molecules in a state with no or little voltage applied. On the inner side of either the substrate 14 or 18 is provided pairs of electrodes (not shown) designed to apply a voltage to the liquid crystal molecules.

FIG. 2 schematically illustrates the alignment of liquid crystal molecules in a pixel size area, i .e., a very small area as small as a single pixel, of the liquid crystal cell 16 (see FIG. 1). FIG. 2 also shows the rubbing direction 4 of the alignment films formed on the inner side of the substrates 14 and 18 and electrodes 2 and 3 for applying a voltage to the liquid crystal molecules between the substrates 14 and 18. When an active drive system is adopted using a nematic liquid crystal compound having positive dielectric anisotropy as a field-effect liquid crystal material, the liquid crystal molecules are aligned in directions 5a and 5b in a state with no or little voltage applied, whereby a black state is obtained. When a voltage is applied between the electrodes 2 and 3, the alignment of the liquid crystal molecules is shifted to directions 6a, 6b according to the voltage. A bright display is usually obtained in this state.

Referring again to FIG. 1, the transmission axis 9 of the first polarizing film 8 and the transmission axis 22 of the second polarizing film 21 are orthogonal to each other. The slow axis 13 of the liquid crystal layer 12 is parallel to the transmission axis 9 of the first polarizing film 8 and the slow axis 17 of the liquid crystal molecules in the liquid crystal cell 16 in a black display state. The liquid crystal layer 12 is disposed closer to the liquid crystal cell 16 than the alignment film 11. The optical characteristics preferred for the alignment film 11 and the liquid crystal layer 12, which constitute the optical compensation film 10, are as previously described.

While in the LCD of FIG. 1 the first polarizing film a is sandwiched between the two protective films 7a and 7b, the protective film 7b may be dispensed with. Instead, the alignment film 11, which is the transparent substrate of the optical compensation film of the invention, serves as a protective film for the polarizing film 8. In the LCD of FIG. 1, the second polarizing film 21 is also held between the two protective films 20a and 20b. It is preferred for the protective film 20a, which is closer to the liquid crystal cell 16, to have a thickness direction retardation Rth of 20 nm or less. Examples of the second polarizing film 21 and its protective films 20a and 20b are same as set forth above.

While the embodiment shown in FIG. 1 is an IPS mode (transmission mode) LCD having upper and lower polarizing plates, the present invention is also applicable to other transmissive, reflective or semi-transmissive LCDs which are of twisted nematic (TN) mode, super twisted nematic (STN) mode, vertical alignment (VA) mode, optically compensated bend cell (OCB) mode, or the like mode. In particular, VA mode, IPS mode and OCB mode are suited to large-size LCD-TV applications. A TN mode LCD of the invention is suitably applicable as well to small and midsize displays with low definition. For applications to large size LCD-TVs, etc., the LCD of the invention is particularly advantageous for a display screen with a size of 20 inches or more measured diagonally across and a resolution of XGA (i.e., 1024×768 at a screen aspect ratio of 3:4) or less.

The configuration of the liquid crystal display of the invention is not limited to that illustrated in FIGS. 1 and 2 and may include additional elements. For example, a color filter may be provided between the liquid crystal cell and the polarizing film. An antireflection treatment or a hard coating may be applied to the surface of the protective film of the polarizing film. An element used in the layer configuration may be endowed with electroconductivity. Where the LCD is a transmissive LCD, a backlight module having a light source, such as a cold or hot cathode fluorescent tube, a light emitting diode, a field emission device or an electroluminescence device, can be provided in the rear of the liquid crystal cell. A reflective polarizing plate, a diffuser, a prism film or a light guide plate may be disposed between the liquid crystal cell and the backlight. The LCD of the invention may be of reflective mode, in which case only one polarizing plate is provided on the viewer's side, and a reflective film is provided on the back of the liquid crystal cell or on the inner side of the lower substrate of the liquid crystal cell. Understandably, it is possible to provide a front light module having the aforementioned light source in the viewer's side of the LCD.

The LCD of the invention includes a direct-view type, a projection type, and a light modulation type. The present invention is particularly effective in active matrix LCDs using three-or two-terminal semiconductor devices, such as TFT and MIM. Understandably, the invention is also effective in application to passive matrix LCDs called time-shared drive.

### EXAMPLES

The present invention will now be illustrated in greater detail with reference to Examples in view of Comparative Example, but it should be understood that the invention is not limited thereto. Unless otherwise noted, all the percents and parts are by weight.

### COMPARATIVE EXAMPLE 1

(1) Preparation of IPS mode liquid crystal cell 1

Electrodes were provided on a glass substrate at 20 μm spacing as illustrated in FIG. 2 (electrodes 2 and 3 in FIG. 2). A polyimide film was formed thereon as an alignment film and subjected to a rubbing treatment in a direction 4. Similarly, a polyimide film was formed on another glass plate and rubbed to obtain an alignment film. The two glass substrates were bonded together with a space (gap d) of 3.9 μm therebetween in such a manner that the alignment films faced each other and the rubbing directions were mutually parallel. A nematic liquid crystal composition having a refractive index anisotropy (Δn) of 0.0769 and a positive dielectric anisotropy (Δε) of 4.5 was sealed in the gap to prepare IPS mode liquid crystal cell 1. The liquid crystal cell had a retardation value of 300 nm.

(2) Preparation of optical compensatory film 1

(2-1) Preparation of substrate

The following components were put in a mixing tank and agitated under heat to dissolve thereby to provide a cellulose acetate solution of the following formulation.

Formulation of cellulose acetate solution:

| | | |
|---|---|---|
| Cellulose acetate with acetylation degree of 60.9% | 100 | parts |
| Triphenyl phosphate (plasticizer) | 7.8 | parts |
| Biphenyl diphenyl phosphate (plasticizer) | 3.9 | parts |
| Methylene chloride (first solvent) | 300 | parts |
| Methanol (second solvent) | 54 | parts |
| 1-Butanol (third solvent) | 11 | parts |

Separately, 16 parts of a retardation increasing agent shown below, 80 parts of methylene chloride, and 20 parts of methanol were put into another mixing tank and agitated under heat to prepare a retardation increasing agent solution. Mixing and well agitating 487 parts of the cellulose acetate solution and 7 parts of the retardation increasing agent solution gave a dope. Retardation increasing agent:

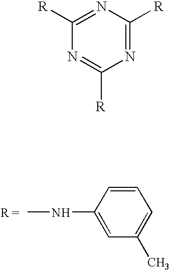

The resulting dope was cast on a band casting machine. When the film surface temperature on the band fell to 40° C., the film was air dried at 60° C. for 1 minute and then stripped off the band. The cast film was further air dried at 140° C. for 10 minutes to obtain cellulose acetate film 1 with a thickness of 80 μm,

The optical characteristics of the film in terms of light incidence angle dependence of retardation were measured with an automatic birefringence meter (KOBRA-21ADH, manufactured by Oji Scientific Instruments). As a result, Re was 5 nm, and Rth was 82 nm.

### (2-2) Preparation of alignment film

The surface of cellulose acetate film 1 prepared in (2-1) above was saponified, and a coating composition for alignment film having the following formulation was applied thereon with a wired bar coater to a thickness of 20 ml/m^{2.} The coating was air dried at 60° C. for 60 seconds and than at 100° C. for 120 seconds. The thus formed film was rubbed in a direction parallel to the slow axis thereof thereby forming an alignment film. Formulation of coating composition for alignment film

| | |
|---|---|
| Modified polyvinyl alcohol (see below) | 10 parts |
| Water | 371 parts |
| Methanol | 119 parts |
| Glutaraldehyde | 0.5 parts |
| Compound B (see below) | 0.2 parts |

Compound B:

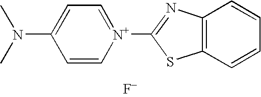

Modified polyvinyl alcohol:

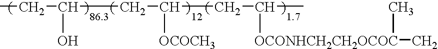

### (2-3) Preparation of liquid crystal layer

A coating composition having the following formulation was applied to the rubbed alignment film with a wired bar to such a thickness as to have a front retardation Re of 130 nm after curing.

### Formulation of coating composition

| | |
|---|---|
| Discotic liquid crystalline compound | 1.8 g |
| Ethylene oxide-modified trimethylolpropane | 0.2 g |
| triacrylate (V#360, available from Osaka Organic | |
| Chemical Industry, Ltd.) | |
| Photopolymerization initiator (Irgacure 907, from | 0.06 g |
| Ciba-Geigy AG) | |
| Sensitizer (Kayacure DETX, from Nippon Kayaku Co., LTD.) | 0.02 g |
| Compound A (see below) (air interface side alignment | 0.01 g |
| agent) | |
| Methyl ethyl ketone | 3.9 g |

The coated substrate was fixed to a metal frame, and the coating layer was heated in a thermostat at 125° C. for 3 minutes to align the discotic liquid crystal compound molecules. The coating film was then irradiated with UV light from a high pressure mercury lamp of 120 W/cm at 100°C. for 30 minutes to crosslink the discotic liquid crystal compound, followed by allowing to cool to room temperature to prepare optical compensation film 1.

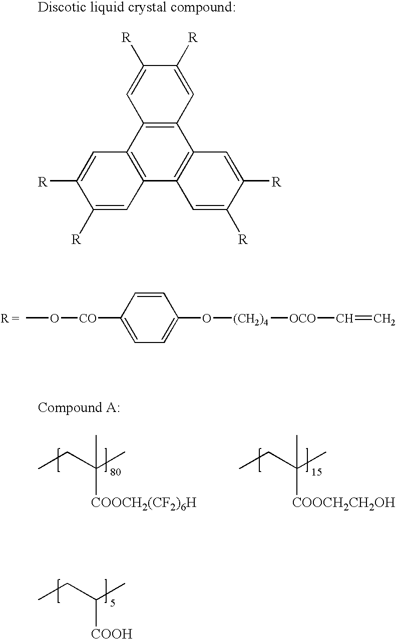

Optical characteristics of optical compensation film 1 in terms of light incidence angle dependence of Re were measured with an automatic birefringence meter (KOBRA-21ADH, manufactured by Oji Scientific Instruments). The Re of optical compensation film 1 was found to be 135 nm. The Re of the cellulose acetate film 1, which had been measured in advance and found to be 5 nm, was subtracted from the measured value (Re=135 nm). As a result, the liquid crystal layer of the film 1 was found to have a front retardation Re of 130 nm. The liquid crystal molecules had a tilt angle of 90.0°, proving that the discotic liquid crystal molecules were aligned with their optical axis parallel to the substrate. The slow axis was parallel to the rubbing direction of the alignment film.

### (3) Preparation of LCD 1

A polarizing film was prepared by adsorption of iodine on a stretched polyvinyl alcohol film. The optical compensation film 1 was bonded, with a polyvinyl alcohol adhesive, to a side of the polarizing film in such a manner that the cellulose acetate film 1 faced the polarizing film and that the transmission axis of the polarizing film was parallel to the slow axis of the optical compensation film 1, which coincided with the slow axis of the alignment film. A commercially available cellulose acetate film (Fujitac TD80UF, from Fuji Photo Film Co., Ltd.) was saponified and bonded via a polyvinyl alcohol adhesive to the opposite side of the polarizing film to prepare a polarizing plate. The polarizing plate was adhered to a side of the IPS mode LCD 1 prepared in (1) above in such a fashion that the slow axis of the optical compensation film was parallel with the rubbing direction of the liquid crystal cell 1 (i.e., the slow axis of the alignment film was parallel with the slow axis of the liquid crystal molecules of the liquid crystal cell 1 in a black display state) and that the discotic liquid crystal layer side faced the liquid crystal cell side. Subsequently, a commercially available polarizing plate (HLC2-5618, from Sanritz Corp.) was bonded to the other side of the liquid cell 1 in a crossed Nicols arrangement to complete LCD 1.

### EXAMPLE 1

LCD 2 was fabricated in the same manner as in Comparative Example 1, except that the UV irradiation for crosslinking the discotic liquid crystal compound on the alignment layer was carried out after a glass plate having been subjected to a rubbing treatment was brought into contact with the air interface side of the liquid crystal layer.

### EXAMPLE 2

LCD 3 was fabricated in the same manner as in Example 1, except that the UV irradiation for crosslinking the discotic liquid crystal compound held between two substrates was carried out while applying a magnetic field of 5 T.

Evaluation of optical performance:

The LCDs prepared above were evaluated for optical performance as follows. Fuji Light Box 5000 Inverter (available from Fuji Photo Film) was used as a light source with an aperture of 3 cm by 3 cm. A voltage was applied to the LCD at a white display voltage of 3.5 v and a black display voltage of 0 V, and the luminance was measured with a spectroradiometer SR-3 (Topcon Corp.) at a viewing field angle of 1° from two directions, a frontal direction and an oblique direction at an azimuth angle of 45° from the absorption axis of the polarizing plate and a polar angle of 45°. The contrast was calculated for each viewing direction. A reduction of front contrast from that obtained with no optical compensation film inserted, and a reduction of contrast at an oblique viewing angle from that of LCD 1 (Comparative Example 1) were obtained. Additionally, black representation was evaluated with the naked eye. Furthermore, a dispersion of alignment was measured by the aforementioned method. The results obtained are shown in Table 1 below.

TABLE 1

| | Dispersion | Reduction in | | |
|---|---|---|---|---|
| | of | Contrast (%) | | |
| | Alignment | | Oblique | |
| | (°) | Front | (45°) | Black Representation |
| Compara. | 0.6 | 20 | — | Front blackness is |
| Example 1 | | | | unfavorable. Black |
| | | | | brightening in an |
| | | | | oblique view is not so |
| | | | | noticeable. |
| Example 1 | 0.3 | 5 | 1 | Front blackness is |
| | | | | agreeable. Black |
| | | | | brightening in an |
| | | | | oblique view is not so |
| | | | | noticeable. |
| Example 2 | 0.2 | 2 | 0 | Front blackness is |
| | | | | agreeable. Black |
| | | | | brightening in an |
| | | | | oblique view is not so |
| | | | | noticeable. |

The results in Table 1 prove that the LCDs having the optical compensation film of the invention exhibit superior display performance with a reduced reduction in front contrast.

This application is based on Japanese Patent application JP2005-69306, filed Mar. 11, 2005, the entire content of which is hereby incorporated by reference, the same as if set forth at length.

What is claimed is:

1. An optical compensation film comprising a liquid crystal layer containing a liquid crystal having a dispersion of alignment of 0.3 ° or smaller.

2. The optical compensation film as claimed in claim 1, wherein the liquid crystal comprises a negative uniaxial liquid crystal compound.

3. The optical compensation film as claimed in claim 1, wherein the dispersion of alignment is 0.1° or smaller.

4. The optical compensation film as claimed in claim 2, wherein the negative uniaxial liquid crystal compound is a discotic liquid crystal compound having a disc-shaped molecular structure.

5. The optical compensation film as claimed in claim 4, wherein the discotic liquid crystal compound has a polymerizable group.

6. The optical compensation film as claimed in claim 5, wherein the discotic liquid crystal compound has a structure with a polymerizable group bonded to the discotic core thereof.

7. The optical compensation film as claimed in claim 6, wherein the discotic liquid crystal compound has the polymerizable group bonded to the discotic core via a linking group.

8. The optical compensation film as claimed in claim 4, wherein the discotic liquid crystal compound is represented by the following formula:
D (-L-P)n
wherein D is a discotic core; L is a divalent linking group; P is a polymerizable group; and n is an integer of 4 to 12.

9. An elliptical polarizing plate comprising the optical compensation film as claimed in claim 1.

10. A liquid crystal display comprising the optical compensation film as claimed in claim 1.

11. A liquid crystal display comprising the elliptical polarizing plate as claimed in claim 9.
